(19) United States
(12) Patent Application Publication
(10) Pub. No.: US 2022/0318896 A1
(43) Pub. Date: Oct. 6, 2022

(54) SYSTEM AND METHOD FOR LOSS AND LIABILITY PREVENTION

(71) Applicant: Wizz Systems, LLC, Metairie, LA (US)

(72) Inventors: Andrey Stanovnov, Kenner, LA (US); Randall Howard, Thibodaux, LA (US); Harry Boileau, New Orleans, LA (US)

(73) Assignee: Wizz Systems, LLC, Metairie, LA (US)

(21) Appl. No.: 17/312,751

(22) PCT Filed: Apr. 15, 2020
(86) PCT No.: PCT/US2020/028218

§ 371 Date: Jun. 10, 2021

Related U.S. Application Data
(60) Provisional application No. 62/950,046, filed on Dec. 18, 2019.

(51) Int. Cl. G06Q 40/00; G06F 21/44

(52) U.S. Cl. CPC G06Q 40/00; G06F 21/44

(57) ABSTRACT

A system and method for reducing loss for retail stores is provided. In one aspect, the system prevents loss caused by fraudulent returns. In another aspect, the system prevents loss by increasing worker efficiency. The system generally comprises a computing entity having a user interface, a processor operably connected to said computing entity, a scanning device operably connected to the processor, and a non-transitory computer-readable medium having instructions stored thereon. The system generates return actions, which may instruct a user whether or not to process a return.

### CROSS REFERENCES

This application claims the benefit of U.S. Provisional Application No. 62/950,046, filed on Dec. 18, 2019, and international application No. PCT/US20/28218, filed on Apr. 15, 2020, which applications are incorporated herein by reference.

### FIELD OF THE DISCLOSURE

The subject matter of the present disclosure refers generally to a system and method for preventing losses common to retail stores.

### BACKGROUND

Fraudulent product returns are currently a major issue leading to financial loss for retail businesses. One method scammers use to fraudulently return items to a store is by acquiring authentic receipts associated with items purchased by real customers and taking the items listed on the authentic receipts off of a retailer's shelves. The scammer then presents the items taken from the shelves along with the authentic receipt to in store customer service team members as if they had purchased the items. Because customer service has no method to determine who actually purchased these items and who is returning them, customer service processes the return as if it is not fraudulent and the scammer receives a refund, thus costing the retailer money. Often, individuals who successfully complete this fraudulent return process will visit multiple stores in a geographic area, which will cause an even larger financial losses for the business.

These same retailers experience fraudulent slip and fall liability claims related to accidents that allegedly occur within the retailer's physical environment. During the litigation process, paper logs, used to record the date and time that a retailer's floor care operations occurred, are used as evidence to support or dispute the claims. Unfortunately, it is far too common for employees to fill out these paper logs arbitrarily, recording that floor care operations have been completed every hour, on the hour, exactly, when in reality these times are not accurate. Since these paper logs do not have accurate date and time data, they are not a reliable piece of evidence that can be used to show a floor had been cleaned and checked in accordance with the retailer's policy, which would therefore suggest the retailer did everything within their power to prevent an accident from taking place.

Further, retailers experience loss of high value, not for sale, physical assets within their in store environments. For example, scan guns used by employees to scan retailers' inventory often go missing. Currently, there is no reliable method that retailers can use to determine which employee is in possession of which high value equipment at any given point in time. Additionally, these high value assets must be replaced by the retailers at their expense in order to sustain operational efficiency, which results in additional financial loss for the business. Also, vendors and other (non-customer) guests that visit the physical store all must sign an agreement stating that they will adhere to the retailers' policies and regulations. Currently, retailers have no reliable, fraud-resistant friendly method to determine whether a vendor or guest has signed an agreement. Nor do retailers have an efficient method to determine whether the agreement has been updated since the last time a vendor or guest visited. Furthermore, there is no reliable way for a retailer to determine how many times a vendor visited a retail location without introducing the opportunity for fraudulent reporting via a paper log. If a vendor is supposed to visit a retail location multiple times per week but only visits once, this can result in either a surplus or shortage of inventory, which can also lead to financial loss for the retailer.

Therefore, there is a need in the art for a system and method that helps retail stores prevent loss and liability caused by fraud and employee inefficiency.

### SUMMARY

A system and method for reducing loss for retail stores is provided. In one aspect, the system prevents loss caused by fraudulent returns. In another aspect, the system prevents loss by increasing worker efficiency. The system generally comprises a computing entity having a user interface, a processor operably connected to said computing entity, a scanning device operably connected to the processor, and a non-transitory computer-readable medium having instructions stored thereon. One preferred embodiment of the system may comprise a database operably connected to the processor, which may allow the system to store data non-locally.

The scanning device allows a user to scan customer identification and identifiable items, which the system may convert into customer data and item data, respectively. The system may then store this customer data and item data within a customer profile of the system, which it may then use at a later time to generate return actions. The system may also comprise a plurality of operations timers, which users of the system may reset after completing a task associated with the operations timer. The system may use indicia to indicate which operations timers need their associated tasks completed most urgently. The indicia displayed to a user may be based on an urgency level of the operations timer. The urgency level may be a value assigned to an operations timer based on a set of urgency parameters and urgency thresholds. The system may also be used to keep track of valuable equipment owned by a retail store and used by its employees. The scanning device of the system may be used to scan a piece of equipment and associate the equipment with a user profile, which will allow management to keep track of the location of equipment at all times. The user interface of the system allows users to perform of these tasks on a single computing entity.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purpose of the system and method disclosed herein. Those skilled in the pertinent art should also realize that such equivalent designs or modifications do not depart from the scope of the system and method of the present disclosure.

### DESCRIPTON OF THE DRAWINGS

These and other features, aspects, and advantages of the present disclosure will become better understood with regard to the following description, appended claims, and accompanying drawings where:

FIG. 1 is a diagram of an example environment in which techniques described herein may be implemented.

FIG. 2 is a diagram of an example environment in which techniques described herein may be implemented.

FIG. 3 is a diagram of an example environment in which techniques described herein may be implemented.

FIG. 4 is a diagram of an example environment in which techniques described herein may be implemented.

FIG. 5 is an illustration of a user interface in which the techniques described herein may be implemented

FIG. 6 is an illustration of a user interface in which the techniques described herein may be implemented

FIG. 7 is a diagram illustrating the manner in which individual access to data may be granted or limited based on user or system roles.

FIG. 8 is a flow chart illustrating certain method steps of a method embodying features consistent with the principles of the present disclosure.

FIG. 9 is a flow chart illustrating certain method steps of a method embodying features consistent with the principles of the present disclosure.

FIG. 10 is a flow chart illustrating certain method steps of a method embodying features consistent with the principles of the present disclosure.

FIG. 11 is a flow chart illustrating certain method steps of a method embodying features consistent with the principles of the present disclosure.

FIG. 12 is a flow chart illustrating certain method steps of a method embodying features consistent with the principles of the present disclosure.

FIG. 13 is a flow chart illustrating certain method steps of a method embodying features consistent with the principles of the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For instance, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, steps, etc. are optionally present. For instance, a system “comprising” components A, B, and C can contain only components A, B, and C, or can contain not only components A, B, and C, but also one or more other components. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility). As will be evident from the disclosure provided below, the present invention satisfies the need for a system and method capable of reducing losses common to retail stores, including, but not limited to, fraud, inefficiency, and asset mismanagement.

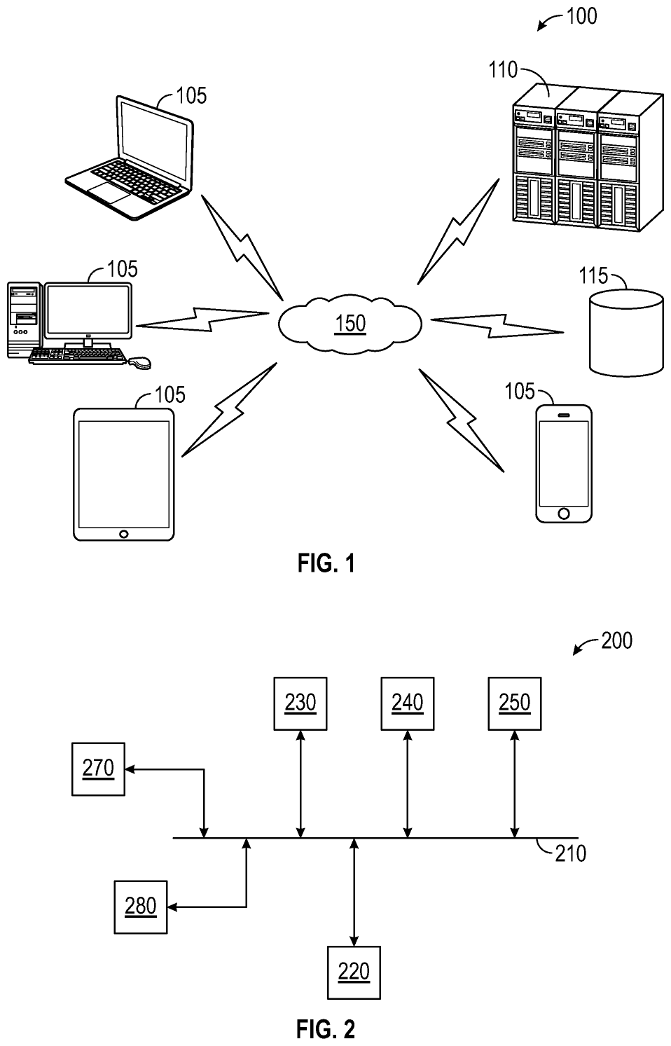

FIG. 1 depicts an exemplary environment 100 of the system 400 consisting of clients 105 connected to a server 110 and/or database 115 via a network 150. Clients 105 are devices of users 405 that may be used to access servers 110 and/or databases 115 through a network 150. A network 150 may comprise of one or more networks of any kind, including, but not limited to, a local area network (LAN), a wide area network (WAN), metropolitan area networks (MAN), a telephone network, such as the Public Switched Telephone Network (PSTN), an intranet, the Internet, a memory device, another type of network, or a combination of networks. In a preferred embodiment, computing entities 200 may act as clients 105 for a user 405. For instance, a client 105 may include a personal computer, a wireless telephone, a personal digital assistant (PDA), a laptop, a smart phone, a tablet computer, or another type of computation or communication device. Servers 110 may include devices that access, fetch, aggregate, process, search, provide, and/or maintain documents. Although FIG. 1 depicts a preferred embodiment of an environment 100 for the system 400, in other implementations, the environment 100 may contain fewer components, different components, differently arranged components, and/or additional components than those depicted in FIG. 1. Alternatively, or additionally, one or more components of the environment 100 may perform one or more other tasks described as being performed by one or more other components of the environment 100.

As depicted in FIG. 1, one embodiment of the system 400 may comprise a server 110. Although shown as a single server 110 in FIG. 1, a server 110 may, in some implementations, be implemented as multiple devices interlinked together via the network 150, wherein the devices may be distributed over a large geographic area and performing different functions or similar functions. For instance, two or more servers 110 may be implemented to work as a single server 110 performing the same tasks. Alternatively, one server 110 may perform the functions of multiple servers 110. For instance, a single server 110 may perform the tasks of a web server and an indexing server 110. Additionally, it is understood that multiple servers 110 may be used to operably connect the processor 220 to the database 115 and/or other content repositories. The processor 220 may be operably connected to the server 110 via wired or wireless connection. Types of servers 110 that may be used by the system 400 include, but are not limited to, search servers, document indexing servers, and web servers, or any combination thereof.

Search servers may include one or more computing entities 200 designed to implement a search engine, such as a documents/records search engine, general webpage search engine, etc. Search servers may, for example, include one or more web servers designed to receive search queries and/or inputs from users 405, search one or more databases 115 in response to the search queries and/or inputs, and provide documents or information, relevant to the search queries and/or inputs, to users 405. In some implementations, search servers may include a web search server that may provide webpages 500 to users 405, wherein a provided webpage 500 may include a reference to a web server at which the desired information and/or links are located. The references to the web server at which the desired information is located may be included in a frame and/or text box, or as a link to the desired information/document. Document indexing servers may include one or more devices designed to index documents available through networks 150. Document indexing servers may access other servers 110, such as web servers that host content, to index the content. In some implementations, document indexing servers may index documents/records stored by other servers 110 connected to the network 150. Document indexing servers may, for example, store and index content, information, and documents relating to user accounts and user-generated content. Web servers may include servers 110 that provide webpages 500 to clients 105. For instance, the webpages 500 may be HTML-based webpages. A web server may host one or more websites. As used herein, a website may refer to a collection of related webpages 500. Frequently, a website may be associated with a single domain name, although some websites may potentially encompass more than one domain name. The concepts described herein may be applied on a per-website basis. Alternatively, in some implementations, the concepts described herein may be applied on a per-webpage basis.

As used herein, a database 115 refers to a set of related data and the way it is organized. Access to this data is usually provided by a database management system (DBMS) consisting of an integrated set of computer software that allows users 405 to interact with one or more databases 115 and provides access to all of the data contained in the database 115. The DBMS provides various functions that allow entry, storage and retrieval of large quantities of information and provides ways to manage how that information is organized. Because of the close relationship between the database 115 and the DBMS, as used herein, the term database 115 refers to both a database 115 and DBMS.

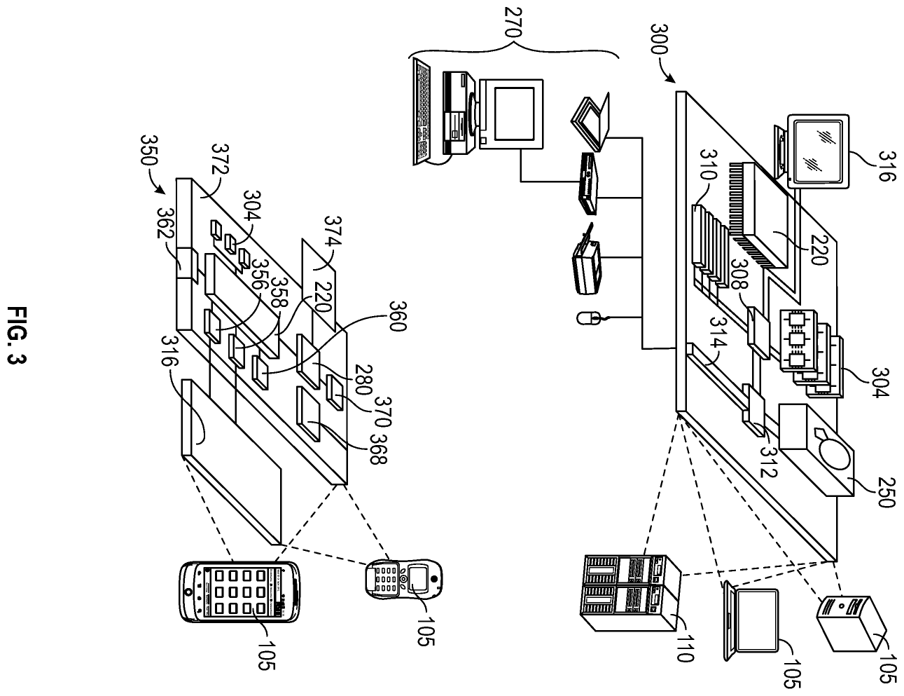

FIG. 2 is an exemplary diagram of a client 105, server 110, and/or or database 115 (hereinafter collectively referred to as “computing entity 200”), which may correspond to one or more of the clients 105, servers 110, and databases 115 according to an implementation consistent with the principles of the invention as described herein. The computing entity 200 may comprise a bus 210, a processor 220, memory 304, a storage device 250, a peripheral device 270, and a communication interface 280. The bus 210 may be defined as one or more conductors that permit communication among the components of the computing entity 200. The processor 220 may be defined as a logic circuitry that responds to and processes the basic instructions that drive the computing entity 200. Memory 304 may be defined as the integrated circuitry that stores information for immediate use in a computing entity 200. A peripheral device 270 may be defined as any hardware used by a user 405 and/or the computing entity 200 to facilitate communicate between the two. A storage device 250 may be defined as a device used to provide mass storage to a computing entity 200. A communication interface 280 may be defined as any transceiver-like device that enables the computing entity 200 to communicate with other devices and/or computing entities 200.

The bus 210 may comprise a high-speed interface 308 and/or a low-speed interface 312 that connects the various components together in a way such they may communicate with one another. A high-speed interface 308 manages bandwidth-intensive operations for computing device 300, while a low-speed interface 312 manages lower bandwidth-intensive operations. In some preferred embodiments, the high-speed interface 308 of a bus 210 may be coupled to the memory 304, display 316, and to high-speed expansion ports 310, which may accept various expansion cards such as a graphics processing unit (GPU). In other preferred embodiments, the low-speed interface 312 of a bus 210 may be coupled to a storage device 250 and low-speed expansion ports 314. The low-speed expansion ports 314 may include various communication ports, such as USB, Bluetooth, Ethernet, wireless Ethernet, etc. Additionally, the low-speed expansion ports 314 may be coupled to one or more peripheral devices 270, such as a keyboard, pointing device, scanner, and/or a networking device, wherein the low-speed expansion ports 314 facilitate the transfer of input data from the peripheral devices 270 to the processor 220 via the low-speed interface 312.

The processor 220 may comprise any type of conventional processor or microprocessor that interprets and executes computer readable instructions. The processor 220 is configured to perform the operations disclosed herein based on instructions stored within the system 400. The processor 220 may process instructions for execution within the computing entity 200, including instructions stored in memory 304 or on a storage device 250, to display graphical information for a graphical user interface (GUI) on an external peripheral device 270, such as a display 316. The processor 220 may provide for coordination of the other components of a computing entity 200, such as control of user interfaces 410, applications run by a computing entity 200, and wireless communication by a communication device of the computing entity 200. The processor 220 may be any processor or microprocessor suitable for executing instructions. In some embodiments, the processor 220 may have a memory device therein or coupled thereto suitable for storing the data, content, or other information or material disclosed herein. In some instances, the processor 220 may be a component of a larger computing entity 200. A computing entity 200 that may house the processor 220 therein may include, but are not limited to, laptops, desktops, workstations, personal digital assistants, servers, mainframes, cellular telephones, tablet computers, or any other similar device. Accordingly, the inventive subject matter disclosed herein, in full or in part, may be implemented or utilized in devices including, but are not limited to, laptops, desktops, workstations, personal digital assistants, servers, mainframes, cellular telephones, tablet computers, or any other similar device.

Memory 304 stores information within computing device 300. In some preferred embodiments, memory 304 may include one or more volatile memory units. In another preferred embodiment, memory 304 may include one or more non-volatile memory units. Memory 304 may also include another form of computer-readable medium 415, such as a magnetic or optical disk. For instance, a portion of a magnetic hard drive may be partitioned as a dynamic scratch space to allow for temporary storage of information that may be used by the processor 220 when faster types of memory, such as random-access memory (RAM), are in high demand. A computer-readable medium 415 may refer to a non-transitory computer-readable memory device. A memory device may refer to storage space within a single storage device 250 or spread across multiple storage devices 250. The memory 304 may comprise main memory 230 and/or read only memory (ROM) 240. In a preferred embodiment, the main memory 230 may comprise RAM or another type of dynamic storage device 250 that stores information and instructions for execution by the processor 220. ROM 240 may comprise a conventional ROM device or another type of static storage device 250 that stores static information and instructions for use by processor 220. The storage device 250 may comprise a magnetic and/or optical recording medium and its corresponding drive.

As mentioned earlier, a peripheral device 270 is a device that facilitates communication between a user 405 and the processor 220. The peripheral device 270 may include, but is not limited to, an input device and/or an output device. As used herein, an input device may be defined as a device that allows a user 405 to input data and instructions that is then converted into a pattern of electrical signals in binary code that are comprehensible to a computing entity 200. An input device of the peripheral device 270 may include one or more conventional devices that permit a user 405 to input information into the computing entity 200, such as a scanner, phone, camera, scanning device, keyboard, a mouse, a pen, voice recognition and/or biometric mechanisms, etc. As used herein, an output device may be defined as a device that translates the electronic signals received from a computing entity 200 into a form intelligible to the user 405. An output device of the peripheral device 270 may include one or more conventional devices that output information to a user 405, including a display 316, a printer, a speaker, an alarm, a projector, etc. Additionally, storage devices 250, such as CD-ROM drives, and other computing entities 200 may act as a peripheral device 270 that may act independently from the operably connected computing entity 200. For instance, a fitness tracker may transfer data to a smartphone, wherein the smartphone may use that data in a manner separate from the fitness tracker.

The storage device 250 is capable of providing the computing entity 200 mass storage. In some embodiments, the storage device 250 may comprise a computer-readable medium 415 such as the memory 304, storage device 250, or memory 304 on the processor 220. A computer-readable medium 415 may be defined as one or more physical or logical memory devices and/or carrier waves. Devices that may act as a computer readable medium 415 include, but are not limited to, a hard disk device, optical disk device, tape device, flash memory or other similar solid-state memory device, or an array of devices, including devices in a storage area network or other configurations. Examples of computer-readable mediums 405 include, but are not limited to, magnetic media such as hard disks, floppy disks, and magnetic tape; optical media such as CD ROM discs and DVDs; magneto-optical media such as optical discs; and hardware devices that are specially configured to store and perform programming instructions, such as ROM 240, RAM, flash memory, and the like.

In an embodiment, a computer program may be tangibly embodied in the storage device 250. The computer program may contain instructions that, when executed by the processor 220, performs one or more steps that comprise a method, such as those methods described herein. The instructions within a computer program may be carried to the processor 220 via the bus 210. Alternatively, the computer program may be carried to a computer-readable medium 415, wherein the information may then be accessed from the computer-readable medium 415 by the processor 220 via the bus 210 as needed. In a preferred embodiment, the software instructions may be read into memory 304 from another computer-readable medium 415, such as data storage device 250, or from another device via the communication interface 280. Alternatively, hardwired circuitry may be used in place of or in combination with software instructions to implement processes consistent with the principles as described herein. Thus, implementations consistent with the invention as described herein are not limited to any specific combination of hardware circuitry and software.

FIG. 3 depicts exemplary computing entities 200 in the form of a computing device 300 and mobile computing device 350, which may be used to carry out the various embodiments of the invention as described herein. A computing device 300 is intended to represent various forms of digital computers, such as laptops, desktops, workstations, servers, databases, mainframes, and other appropriate computers. A mobile computing device 350 is intended to represent various forms of mobile devices, such as scanners, scanning devices, personal digital assistants, cellular telephones, smart phones, tablet computers, and other similar devices. The various components depicted in FIG. 3, as well as their connections, relationships, and functions are meant to be examples only, and are not meant to limit the implementations of the invention as described herein. The computing device 300 may be implemented in a number of different forms, as shown in FIGS. 1 and 3. For instance, a computing device 300 may be implemented as a server 110 or in a group of servers 110. Computing devices 300 may also be implemented as part of a rack server system. In addition, a computing device 300 may be implemented as a personal computer, such as a desktop computer or laptop computer. Alternatively, components from a computing device 300 may be combined with other components in a mobile device, thus creating a mobile computing device 350. Each mobile computing device 350 may contain one or more computing devices 300 and mobile devices, and an entire system may be made up of multiple computing devices 300 and mobile devices communicating with each other as depicted by the mobile computing device 350 in FIG. 3. The computing entities 200 consistent with the principles of the invention as disclosed herein may perform certain receiving, communicating, generating, output providing, correlating, and storing operations as needed to perform the various methods as described in greater detail below.

In the embodiment depicted in FIG. 3, a computing device 300 may include a processor 220, memory 304 a storage device 250, high-speed expansion ports 310, low-speed expansion ports 314, and bus 210 operably connecting the processor 220, memory 304, storage device 250, high-speed expansion ports 310, and low-speed expansion ports 314. In one preferred embodiment, the bus 210 may comprise a high-speed interface 308 connecting the processor 220 to the memory 304 and high-speed expansion ports 310 as well as a low-speed interface 312 connecting to the low-speed expansion ports 314 and the storage device 250. Because each of the components are interconnected using the bus 210, they may be mounted on a common motherboard as depicted in FIG. 3 or in other manners as appropriate. The processor 220 may process instructions for execution within the computing device 300, including instructions stored in memory 304 or on the storage device 250. Processing these instructions may cause the computing device 300 to display graphical information for a GUI on an output device, such as a display 316 coupled to the high-speed interface 308. In other implementations, multiple processors and/or multiple buses may be used, as appropriate, along with multiple memory units and/or multiple types of memory. Additionally, multiple computing devices may be connected, wherein each device provides portions of the necessary operations.

A mobile computing device 350 may include a processor 220, memory 304 a peripheral device 270 (such as a display 316, a communication interface 280, and a transceiver 368, among other components). A mobile computing device 350 may also be provided with a storage device 250, such as a micro-drive or other previously mentioned storage device 250, to provide additional storage. Preferably, each of the components of the mobile computing device 350 are interconnected using a bus 210, which may allow several of the components of the mobile computing device 350 to be mounted on a common motherboard as depicted in FIG. 3 or in other manners as appropriate. In some implementations, a computer program may be tangibly embodied in an information carrier. The computer program may contain instructions that, when executed by the processor 220, perform one or more methods, such as those described herein. The information carrier is preferably a computer-readable medium 415, such as memory, expansion memory 374, or memory 304 on the processor 220 such as ROM 240, that may be received via the transceiver or external interface 362. The mobile computing device 350 may be implemented in a number of different forms, as shown in FIG. 3. For example, a mobile computing device 350 may be implemented as a cellular telephone, part of a smart phone, personal digital assistant, or other similar mobile device.

The processor 220 may execute instructions within the mobile computing device 350, including instructions stored in the memory 304 and/or storage device 250. The processor 220 may be implemented as a chipset of chips that may include separate and multiple analog and/or digital processors. The processor 220 may provide for coordination of the other components of the mobile computing device 350, such as control of the user interfaces 410, applications run by the mobile computing device 350, and wireless communication by the mobile computing device 350. The processor 220 of the mobile computing device 350 may communicate with a user 405 through the control interface 358 coupled to a peripheral device 270 and the display interface 356 coupled to a display 316. The display 316 of the mobile computing device 350 may include, but is not limited to, Liquid Crystal Display (LCD), Light Emitting Diode (LED) display, Organic Light Emitting Diode (OLED) display, and Plasma Display Panel (PDP), or any combination thereof. The display interface 356 may include appropriate circuitry for causing the display 316 to present graphical and other information to a user 405. The control interface 358 may receive commands from a user 405 via a peripheral device 270 and convert the commands into a computer readable signal for the processor 220. In addition, an external interface 362 may be provided in communication with processor 220, which may enable near area communication of the mobile computing device 350 with other devices. The external interface 362 may provide for wired communications in some implementations or wireless communication in other implementations. In a preferred embodiment, multiple interfaces may be used in a single mobile computing device 350 as is depicted in FIG. 3.

Memory 304 stores information within the mobile computing device 350. Devices that may act as memory 304 for the mobile computing device 350 include, but are not limited to computer-readable media, volatile memory, and non-volatile memory. Expansion memory 374 may also be provided and connected to the mobile computing device 350 through an expansion interface 372, which may include a Single In-Line Memory Module (SIM) card interface or micro secure digital (Micro-SD) card interface. Expansion memory 374 may include, but is not limited to, various types of flash memory and non-volatile random-access memory (NVRAM). Such expansion memory 374 may provide extra storage space for the mobile computing device 350. In addition, expansion memory 374 may store computer programs or other information that may be used by the mobile computing device 350. For instance, expansion memory 374 may have instructions stored thereon that, when carried out by the processor 220, cause the mobile computing device 350 perform the methods described herein. Further, expansion memory 374 may have secure information stored thereon; therefore, expansion memory 374 may be provided as a security module for a mobile computing device 350, wherein the security module may be programmed with instructions that permit secure use of a mobile computing device 350. In addition, expansion memory 374 having secure applications and secure information stored thereon may allow a user 405 to place identifying information on the expansion memory 374 via the mobile computing device 350 in a non-hackable manner.

A mobile computing device 350 may communicate wirelessly through the communication interface 280, which may include digital signal processing circuitry where necessary. The communication interface 280 may provide for communications under various modes or protocols, including, but not limited to, Global System Mobile Communication (GSM), Short Message Services (SMS), Enterprise Messaging System, Multimedia Messaging Service (MMS), Code Division Multiple Access (CDMA), Time Division Multiple Access (TDMA), Personal Digital Cellular (PDC), Wideband Code Division Multiple Access (WCDMA), IMT Multi-Carrier (CDMAX 0) , and General Packet Radio Service (GPRS), or any combination thereof. Such communication may occur, for example, through a transceiver 368. Short-range communication may occur, such as using a Bluetooth, WIFI, or other such transceiver 368. In addition, a Global Positioning System (GPS) receiver module 370 may provide additional navigation-and location-related wireless data to the mobile computing device 350, which may be used as appropriate by applications running on the mobile computing device 350. Alternatively, the mobile computing device 350 may communicate audibly using an audio codec 360, which may receive spoken information from a user 405 and covert the received spoken information into a digital form that may be processed by the processor 220. The audio codec 360 may likewise generate audible sound for a user 405, such as through a speaker, e.g., in a handset of mobile computing device 350. Such sound may include sound from voice telephone calls, recorded sound such as voice messages, music files, etc. Sound may also include sound generated by applications operating on the mobile computing device 350.

The system 400 may also comprise a power supply. The power supply may be any source of power that provides the system 400 with power. In an embodiment, the power supply may be a stationary power outlet. The system 400 may comprise of multiple power supplies that may provide power to the system 400 in different circumstances. For instance, the system 400 may be directly plugged into a stationary power outlet, which may provide power to the system 400 so long as it remains in one place. However, the system 400 may also be connected to a backup battery so that the system 400 may receive power even when the it is not connected to a stationary power outlet or if the stationary power outlet ceases to provide power to the computing entity 200.

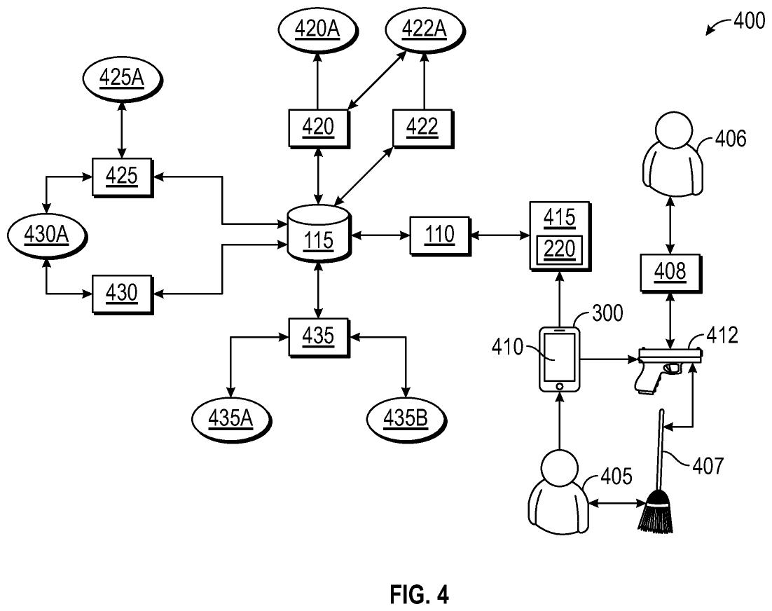

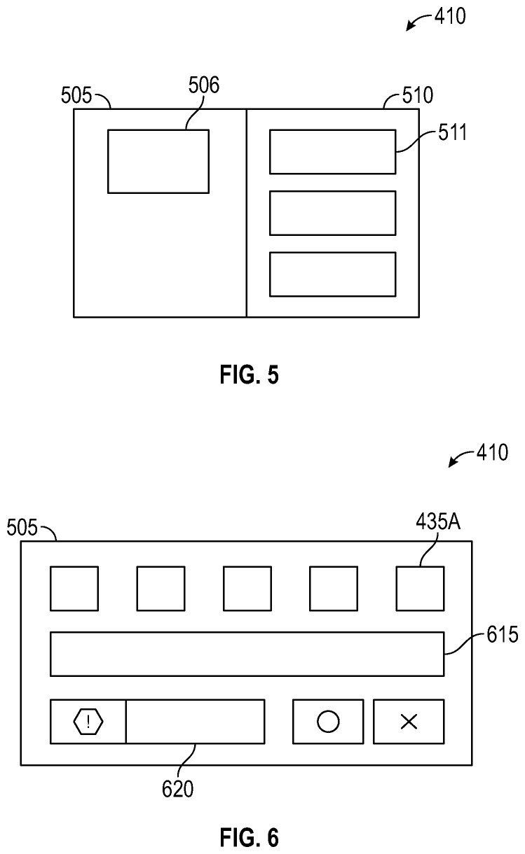

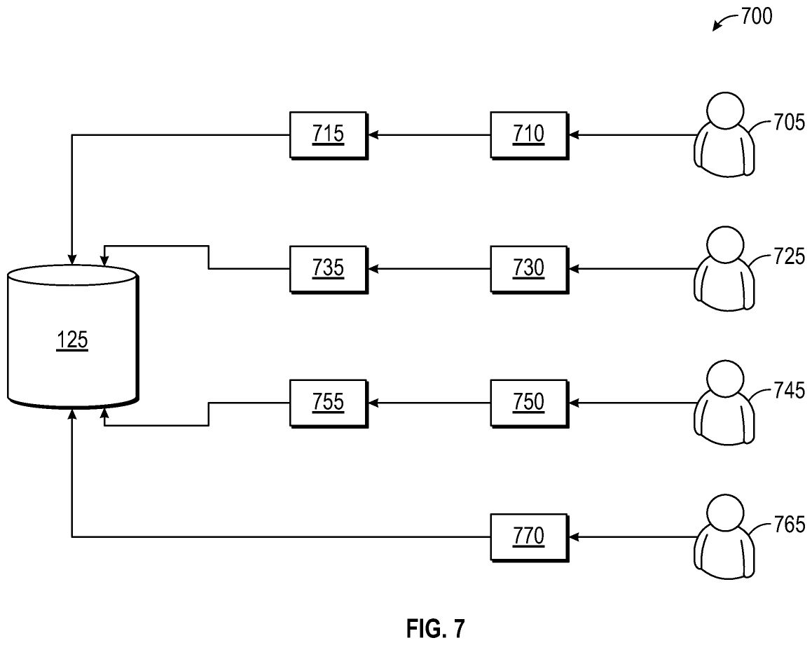

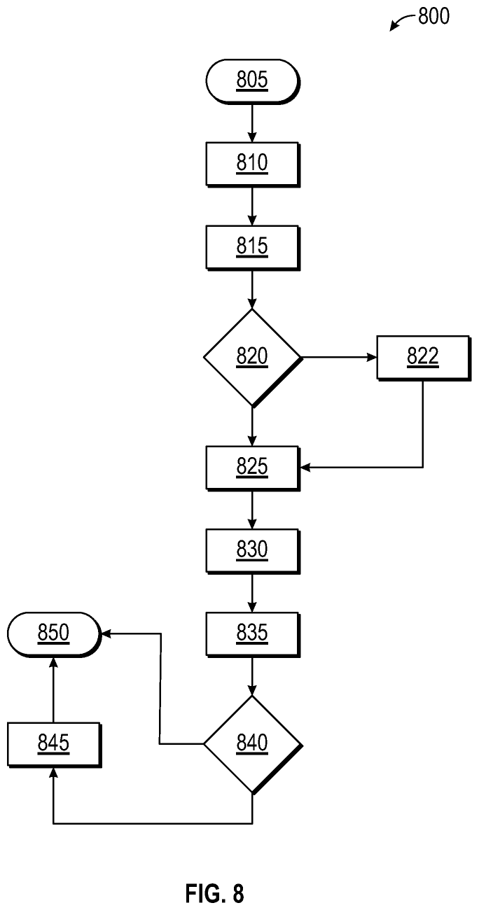

FIGS. 4-12 illustrate embodiments of a system 400 and methods 800, 900, 1000, 1100, 1200, 1300 for preventing losses common to retail stores. In particular, the system 400 and method are designed to prevent fraudulent returns and fraudulent claims. As illustrated in FIG. 4, the system 400 generally comprises a computing entity 200 having a user interface 410, a processor 220 operably connected to said computing entity 200 via a network, a server 110 operably connected to the processor 220 via the network, and a non-transitory computer-readable medium 415 having instructions stored thereon. In one preferred embodiment, a database 115 may be operably connected to the processor 220 and/or server 110 to store the various data of the system 400 non-locally. In another preferred embodiment, a scanning device 412 may be used by the system 400 to collect the various data of the system 400. It is understood that the various method steps associated with the methods of the present disclosure may be carried out as operations by the system 400 shown in FIG. 4. FIGS. 5 and 6 illustrate an example user interface 410 of the system 400. FIG. 7 illustrates permission levels that may be utilized by the system 400 for controlling access to content such as user data 420A, customer data 425A, item data 430A, and equipment data. FIGS. 8-12 illustrate various methods that may be carried out by the system 400.

Data within the system 400 may be stored in various profiles. In a preferred embodiment, the system 400 comprises user data 420A, customer data 425A, item data 430A, and equipment data that may be stored in user profiles 420, customer profiles 425, item profiles 430, and equipment profiles. User data 420A may be defined as data that may be used to identify a particular user 405 of the system 400. Customer data 425A may be defined as data that may be used to identify a particular customer 406 associated with a user profile 420. Item data 430A may be defined as data that may be used to identify an identifiable item 408 or a group of identifiable items 408, such as a receipt. This may allow the system 400 to track which customers 406 have purchased which identifiable items 408 and/or have attempted to return identifiable items 408. Equipment data may be defined as data that may be used to identify a particular piece of equipment 407 of the system 400.

A user profile 420 may be defined as a profile containing data about a particular user 405.

In a preferred embodiment, a user profile 420 may comprise a plurality of user profiles 420, wherein each user profile 420 within the plurality of user profiles 420 may or may not be associated with at least one user 420. For instance, a grocery chain may have a primary user profile and a plurality of region-specific user profiles associated with the primary user profile, wherein the region-specific user profiles may have a plurality of store specific user profiles associated therewith. The system 400 may also separate user profiles 420 into groups and subgroups. In a preferred embodiment, the various groups and subgroups may grant various permissions that give users 405 access to data within the system 400. For instance, the user profile 420 of a department store may comprise a plurality of employee user profiles 420, wherein the employee user profiles 420 may be grouped into managerial groups and associate groups. The system 400 may assign different permissions 700 and thresholds 435 to users 405 within the various groups and sub groups of the system 400. For instance, managerial permission levels may grant user profiles 420 of the manager group access to information that associate permission levels may not grant user profiles 420 of the associate groups. In one preferred embodiment, the system 400 may store both user data 420A and equipment data in user profiles 420, which may allow the system 400 to track which users 405 are in possession of which pieces of equipment 407.

A customer profile 425 may be defined as a profile containing data about a particular customer 406. The customer profile 425 may or may not be associated with a particular user profile 420. For instance, a customer 406 who shops at more than one retail store that uses the system 400 may have a customer profile 425 associated with the user profiles 420 of all retail stores in the system 400. For instance, a customer 406 who shops at more than one retail store that uses the system 400 may have a plurality customer profiles 425, wherein each customer profile 425 of that customer 406 is associated with a single user profile 420 of a particular retail store in the system 400. In one preferred embodiment, a customer profile 425 may comprise a plurality of customer profiles 425, wherein each customer profile 425 within the plurality of customer profiles 425 may or may not be associated with a particular user profile 420. The system 400 may separate customer profiles 425 into groups and subgroups. For instance, a customer profile 425 associated with a grocery store may comprise a plurality of customer profiles 425, wherein the plurality of customer profiles 425 may be grouped into allowed groups, VIP groups, and banned groups. In a preferred embodiment, the system 400 may assign different thresholds 435 to customers 406 within the various groups and sub groups of the system 400. For instance, return thresholds 435A for customers 406 in the allowed group may be different than return thresholds 435A for customers 406 in the VIP group, wherein the customers 406 in the VIP group may be able to return far more identifiable items 408 than customers 406 in the allowed group before the system 400 generates a return action 620 that does not permit a return. In one preferred embodiment, customer profiles 425 may store both customer data 425A and item data 430A, which may allow the system 400 to track which customers 405 have purchased or returned which identifiable items 408.

An item profile 425 may be defined as a profile containing data about a particular identifiable item 408. The item profile 430 may or may not be associated with a particular user profile 420. For instance, an identifiable item 408 in a particular retail box store may have an item profile 430 associated with the user profile 420 of that particular box store so that the system 400 may track where an identifiable item 408 was purchased and returned. In one preferred embodiment, an item profile 430 may comprise a plurality of item profiles 430, wherein each item profile 430 within the plurality of item profiles 430 may or may not be associated with a particular user profile 420. The system 400 may separate item profiles 430 into groups and subgroups. For instance, item profiles 430 may be grouped into aisles of a particular box store. For instance, item profiles may be grouped into high-fraud groups and low-fraud groups, which the system 400 may use to assign different thresholds 435. Identifiable items 408 in the low-fraud group may have thresholds 435 that allow the system 400 to process returns as described herein, whereas identifiable items 408 in the high-fraud group may have thresholds 435 that cause the system 400 to always generate a return action 620 that prevents a return. In one preferred embodiment, item profiles 425 may store both item data 425A and customer data 430A, which may allow the system 400 to track which identifiable items 408 have been returned.

An equipment profile 422 may be defined as a profile containing data about a particular piece of equipment 407. The equipment profile 422 may or may not be associated with a particular user profile 420. For instance, a piece of equipment 407 in a particular retail box store may have an equipment profile 422 associated with an employee profile of an employee that works at said particular box store so that the system 400 may track which employees are using which pieces of equipment 407. In one preferred embodiment, an equipment profile 422 may comprise a plurality of equipment profiles 422, wherein each equipment profile 422 within the plurality of equipment profiles 422 may or may not be associated with a particular user profile 420. The system 400 may separate equipment profiles 422 into groups and subgroups. For instance, equipment profiles 422 may be grouped into work categories such as cleaning and restocking. In one preferred embodiment, the system may require different permissions 435 for a user 405 to associate their user profile 420 with a piece of equipment 407. For instance, a user 405 placed in a cashier subgroup may not have the same permissions as a user 405 placed in the inventory management subgroup, which may prevent said user 405 working as a cashier from associating their user profile 420 with a bar code scanner used for restocking purposes. In one preferred embodiment, equipment profiles 422 may store both equipment data 422A and user data 420A, which may allow the system 400 to track which pieces of equipment 407 have been used by which users 405.

One preferred embodiment of the system 400 may comprise a database 115 operably connected to the processor 220. The database 115 may be configured to store user data 420A within user profiles 420, customer data 425A in customer profiles 425, item data 430A in item profiles 430, and equipment data 422A in equipment profiles 422. Types of data that the system 400 may use as user data 420A may include, but is not limited to, gender, social security number, age, employee number, etc. Types of data that the system 400 may use as customer data 425A may include, but is not limited to, gender, age, payment information, purchase history, return history, receipt number, license number, etc. Types of data that the system 400 may use as item data 430A may include, but is not limited to, brand, food category, return history, perishable status, etc. Types of data that the system 400 may use as equipment data 422A may include, but is not limited to, equipment type, equipment age, use history, etc.

In a preferred embodiment, user profiles 420, customer profiles 425, item profiles 430, and equipment profiles 422 may be related to a particular user 405, customer 406, identifiable item 408, and piece of equipment 407, respectively. However, in other embodiments, user profiles 420, customer profiles 425, item profiles 430, and equipment profiles 422 may relate to multiple users 405, customers 406, identifiable items 408, and pieces of equipment 407 possessing similar characteristics without departing from the inventive subject matter described herein. A user 405 is preferably associated with a particular user profile 420 based on a user identification, such as an employee badge having a bar code associated with said user's 405 user profile 420. A customer 406 is preferably associated with a particular customer profile 425 based on a customer identification such as a driver's license. Identifiable items 408 are preferably associated with a particular item profile 430 using a bar code of the identifiable item 408. Pieces of equipment 407 are preferably associated with an equipment profile 430 using a bar code of the piece of equipment 407. However, it is understood that users 405, customers 406, identifiable items 408, and pieces of equipment 407 may be associated with user profiles 420, customer profiles 425, item profiles 430, and equipment profiles 422 using a variety of methods without departing from the inventive subject matter herein.

As previously mentioned, the system 400 may also comprise a user interface 410. A user interface 410 may be defined as a space where interactions between a user 405 and the system 400 may take place. In an embodiment, the interactions may take place in a way such that a user 405 may control the operations of the system 400. A user interface 410 may include, but is not limited to operating systems, command line user interfaces, conversational interfaces, web-based user interfaces, zooming user interfaces, touch screens, task-based user interfaces, touch user interfaces, text-based user interfaces, intelligent user interfaces, and graphical user interfaces, or any combination thereof. The system 400 may present data within the user interface 410 to the user 405 via a display operably connected to the processor 220. A display may be defined as an output device that communicates data that may include, but is not limited to, visual, auditory, cutaneous, kinesthetic, olfactory, and gustatory, or any combination thereof.

Information presented via a display may be referred to as a soft copy of the information because the information exists electronically and is presented for a temporary period of time. Information stored on the non-transitory computer-readable medium 415 may be referred to as the hard copy of the information. For instance, a display may present a soft copy of visual information via a liquid crystal display (LCD), wherein the hardcopy of the visual information is stored on a local hard drive. For instance, a display may present a soft copy of audio information via a speaker, wherein the hard copy of the audio information is stored on a flash drive. For instance, a display may present a soft copy of visual information via a LCD monitor, wherein the hard copy of the visual information is stored within a database 115. Displays may include, but are not limited to, cathode ray tube monitors, LCD monitors, light emitting diode (LED) monitors, gas plasma monitors, screen readers, speech synthesizers, virtual reality headsets, speakers, and scent generating devices, or any combination thereof.

In one preferred embodiment, as illustrated in FIG. 4, a scanning device 412 operably connected to the processor 220 allows a user 405 to scan customer identification and identifiable items 408 to obtain customer data 425A and item data 430A, respectively. The scanning device 412 may also be used to scan user identification and pieces of equipment 407 to obtain user data 420A and equipment data, respectively. The system 400 may store customer data 425A and item data 430A within a customer profile 425 of the system 400. Customer data 425A and item data 430A may be uploaded to customer profiles 425 automatically via near-field communication (NFC) and/or radio-frequency identification (RFID) but is not limited to these methods. For instance, a scanning device 412 fitted with an RFID sensor may detect identifiable items 408 fitted with an RFID device containing item data 430A. The scanning device 412 may communicate with the processor 220 in a way such that the item data 430A associated with the identifiable item 408 may be automatically uploaded to the customer profile 425 associated with the customer identification. For instance, a scanning device 412 fitted with a sensor may detect an RFID chip in the customer's 406 identification that may transmit customer data 425A to the processor 220 of the system 400. For instance, a cart fitted with a scanning device 412 configured to detect RFID chips implanted within identifiable items 408 may transmit item data 430A to a store's PoS system via an NFC device, which may allow a user 405 to purchase identifiable items 408 without removing them from the cart. In another preferred embodiment, the scanning device 412 may be fitted with a weight sensing device that may detect changes in weight. For instance, when an identifiable item 408 is placed on the scanning device 412, the sensor may determine the weight of the identifiable item 408 and communicate associated item data 430A to the processor 220. The processor 220 may then check the weight of the returned identifiable item 408 against any item data 430A within the system 400. For instance, a customer 406 returning an amount of produce may have their driver's license and receipt scanned by a user 405 of the system. Should the customer 405 be allowed by the system to make a return, the system may check the return weight of the produce against the purchase weight, wherein the return weight and purchase weight were measured by a weight measuring device of the system.

In a preferred embodiment, the scanning device 412 is a bar code scanning device 412, which may be used by a user 405 to scan a bar code of the user identification, identifiable items 408, piece of equipment 407, receipt, etc. In one preferred embodiment, the bar code scanning device 412 may be a component of a larger computing system 400. For instance, the system 400 in the form of a mobile computing entity 200 may be fitted with a bar code scanning device 412 in a way such that the user 405 may use the mobile computing entity 200 to directly obtain user data 420A from a user's identification. For instance, a system 400 in the form of a tablet and having a bar code scanning device 412 may be used to scan a bar code of an identifiable item 408 in a way such that the item data 430A is automatically uploaded to the user interface 410. For instance, a system 400 in the form of a mobile phone may be used to scan a bar code associated with a customer's identification and a receipt in a way such that the system 400 may automatically retrieve customer data 425A and item data 430A associated with that particular customer 406. For instance, the system in the form of a computing device 300 having a bar code gun operably connected thereto may be used to scan the barcode on a receipt to retrieve the purchase/return history of the receipt. The system 400 may then relate receipt data from the scan to the purchase/return history of the receipt to determine whether a receipt was scanned in a return attempt by one customer 406 and then used again by another customer 406 to attempt a potentially fraudulent return.

In one preferred embodiment, the system 400 may be operably connected to a retailer's PoS system via the network 150. Item data 430A may be automatically uploaded to customer profiles 425 when a customer 406 purchases an identifiable item 408 known to the system 400. For instance, the system 400 may be operably connected to a retailer's Point of Sale (PoS) system in a way such that the PoS system may communicate item profiles 430 and item data 430A of identifiable item 408 purchased by the customer 406 to the processor 220, wherein the processor 220 may subsequently store the item profiles 430 and item data 430A in the customer's 406 customer profile 425. Alternatively, item profiles 430 and item data 430A may be uploaded from the PoS to the system 400 and stored on the non-transitory computer-readable medium 415 and/or database 115. When an identifiable item 408 is scanned by the scanning device 412 of the system 400, the system 400 may update the item profile 430 of the system 400 and/or update the item profile 430 within the PoS. For instance, a system 400 connected to the PoS of a retail box store may obtain item data 430A from the PoS of the retail box and store that item data 430A within item profiles 430 on a database 115 of the system 400. When an identifiable item 408 is purchased or returned, the item data 430 in the system 400 may be updated. The system 400 may then communicate with the PoS at a later time so that the item data 430 of the PoS may be updated.

In another preferred embodiment, the PoS system may determine the customer's identity by asking the customer 406 for a form of identification, such as a telephone number or a member number, associated with the customer's 406 customer profile 425. In yet another preferred embodiment, a sensor of the PoS system may automatically pull customer data 425A from an NFC device or RFID device associated within the customer's 406 payment method. Once the customer data 425A and item data 430A have been received by the processor 220 from the NFC device or RFID device, the processor 220 may store them within the customer profile 425. For instance, a RFID sensor of a credit card pin pad may pull a customer's 406 name and address from an RFID chip within the customer's 406 debit/credit card and transmit the customer data 425A and associated item data 430A to the system 400 for storage within a customer profile 425.

As illustrated in FIG. 5, a user 405 may perform returns and view/reset operations timers via a user interface 410. In a preferred embodiment, the user interface 410 may comprise a returns pane 505 and a timers pane 510. The returns pane 505 may allow a user 405 to perform a return for a customer 406 by allowing the user to select the return operation 506 in the user interface. The system 400 may generate a return action 620 that may or may not allow a customer 406 to make a return, depending on the data within the customer's 406 customer profile 425 compared to any return thresholds 435A of the system 400. In a preferred embodiment, the system 400 may require that a user 405 scan a customer's identification and/or receipt prior to returning an identifiable item 408. For instance, the system 400 may require that the bar code of a customer's 406 driver's license be scanned by a scanning device 412 of the system 400 prior to allowing an employee process any returns. For instance, the system 400 may require that an employee scan a bar code on a customer's receipt prior to allowing an employee process any returns. For instance, the system 400 may require that a manager scan a bar code of their employee badge prior to revealing why a customer 406 was denied the ability to return an identifiable item.

As illustrated in FIG. 6, the user interface 410 may display the return history of a customer 406. The return history may include the return attempts of a particular customer 406. In one preferred embodiment, each return attempt may indicate the return status as “approved”, “auto-approved”, “denied”, or “incomplete”. The system 400 may indicate which returns were “approved”, “auto-approved”, “denied”, or “incomplete”using indicia. In a preferred embodiment, successful return attempts may be colored green, unsuccessful return attempts may be colored red, and incomplete return attempts may be colored grey. In another preferred embodiment, the return history may further comprise a return timeline 615 that is navigable by the user 405. The return timeline 615 may be defined a chronological ordering of return attempts made by a particular customer 406 over a given time period that has been charted on a line that represents a linear representation of time. In another preferred embodiment, indicia may indicate which returns along the return timeline 615 were “approved”, “auto-approved”, “denied”, or “incomplete.” In a preferred embodiment, successful return attempts may be colored green, unsuccessful return attempts may be colored red, and incomplete return attempts may be colored grey about the return timeline 615. In yet another preferred embodiment, the return timeline may indicate the store location in which a return attempt was made.

The system 400 may use a plurality of return thresholds 435A to determine a return action 620. Return thresholds 435A may be defined as the minimum or maximum allowable values for a particular parameter that may be indicative of fraud. Parameters that may be used by the system 400 to generate a return action 620 include, but are not limited to, total returned items, total return attempts, total returns stores, total receipt scans, total items returned on receipt, and total returns value, or any combination thereof. Total returned items may be defined as the total number of identifiable items 408 that a customer 406 has ever returned. Total return attempts may be defined as the total number of return attempts a customer 406 has made over a specified time period. Total returns stores may be defined as the total number of stores the customer 406 has attempted to return identifiable items 408. Total receipt scans may be defined as the total number of times a particular receipt of the system 400 has been scanned. Total items returned on receipt may be defined as the total number of identifiable items returned from a particular receipt of the system 400. Total returns value may be defined as the total monetary value of the identifiable items 408 returned by the customer 406.

Return thresholds 435A may be used by the system 400 to generate a return action 620. In one preferred embodiment, the system 400 may generate an “invalid” return action 620 and a “valid” return action 620, wherein an “invalid” return action 620 indicates that a customer 406 has exceeded a return threshold 435A and may not return an item whereas a “valid” return action 620 indicates that a customer 406 has nor exceeded a return threshold 435A and may return an item. For instance, a customer's identification and receipt are scanned by an associate employee of a grocery store, which the system 400 uses to acquire the customer's 406 customer profile 425 containing customer data 425A and item data 430A related to that particular customer 406. If the system 400 had a total return attempts threshold of ten total return attempts in a year and a customer 406 has only attempted to return identifiable items 408 (as indicated by the customer data 430A) on six separate occasions in the past year, the customer 406 will have passed that particular return threshold 435A for that particular return. However, if that same user 405 has attempted to make those six separate returns at four different stores and the system 400 has a total returns store threshold of two total stores, the system 400 will generate an “invalid” return action 620 should that user 405 attempt to return an identifiable item 408 to any store. When a return action 620 is generated by the system 400, the system 400 may generate an indicia to display to the user 405 that alerts the user 405 how to proceed with a particular return. Indicia the system 400 may use to represent a return action 620 include, but are not limited to, text, highlights, checks, X's, strikethroughs, symbols, images, or any other suitable indicator. In a preferred embodiment, a red stop sign is used to indicate an “invalid” return action 620 and a green thumbs up is used to indicate a “valid” return action 620. Valid return actions may indicate that a customer 406 was “approved” or “auto-approved” to return an item by the system 400 and invalid return actions may indicate that a customer 406 was “denied.”

In another preferred embodiment, a customer 406 may be added to a permissions list by a user 405 having appropriate permission levels. In one preferred embodiment, a customer 406 may be added to a banned group, VIP group, or allowed group. Customers 406 added to a VIP group may have return thresholds 435A set in a way such that the system 400 may always generate a “valid” return action 620 for customers 406 within that group. For instance, the system 400 may be configured such that when a customer 406 within the VIP group has their driver's license scanned into the system 400, the system 400 will automatically generate a “valid” return action for that customer 406. In another preferred embodiment, subgroups within the groups may have greater or lesser values for return thresholds 435A depending on the subgroup in which the customer 406 is a part of. For instance, a caterer who frequently uses the store to buy supplies for catering events may be known to make a large number of returns by management. Management may add the caterer to the VIP group and then to the caterer sub group so that the caterer never receives an “invalid” return action 620 while returning an item. On the other hand, a restaurant may be added to the VIP group and then the restaurant sub group, which may only double the threshold limits 435 normally allowed before returning an “invalid” return action 620. Customers 406 added to a banned group may have their return parameters lowered in a way such that it is more difficult or impossible to make any returns. For instance, a customer 406 caught committing return fraud may be added to the banned group so the system 400 will always generate an “invalid” return action 620 for that particular customer 406 no matter the reason for return whenever that customer's 406 customer identification is scanned into the system 400. This may prevent that customer 406 from ever making any returns without first receiving managerial permission.

As illustrated in FIG. 5, the timers pane 510 may allow users 405 to reset operation timers of the system 400 after selecting the timers operation 511 in the user interface 410. Operations timers may be defined as timers that indicate user 405 actions that should be taken by the users 405 in a given period of time. Operations timers that may be implemented by the system 400 include, but are not limited to, restocking timers, maintenance timers, management timers, and vendor timers, or any combination thereof. A restocking timer may be defined as timer that indicates to a user 405 when a particular aisle needs to be restocked with identifiable items 408. A maintenance timer may be defined as timer that indicates to a user 405 when a certain maintenance task needs to be performed in a particular area of a store. A management timer may be defined as timer that indicates to a user 405 when certain managerial tasks must be performed. A vendor timer may be defined as a timer that tells users 405 of the system 400 when a vendor ‘representative’ last visited a particular store location and indicates whether or not a vendor is compliant with an agreed upon schedule. In other words, a vendor timer indicates to users 405 of the system 400 when a store needs a vendor representative's attention so that the vendor representative may determine whether the store needs to be resupplied with identifiable items 408.

In a preferred embodiment, the user 405 may reset the operations timer via a timer reset of the user interface 410 after they have completed the associated user 405 action. For instance, an employee using the system 400 may be required to stock certain areas of a store over the course of a day. A restocking timer of the user interface 410 may indicate to the employee exactly what needs to be restocked at what times. When the employee completes the required restocking task, the employee may reset the restocking timer via a timer reset button of the user interface 410. In another preferred embodiment, a user 405 must be logged into the system 400 to reset a timer. Once logged into the system 400, the system 400 may require a user 405 have certain permission levels to reset a particular operations timer. For instance, a vendor timer of the user interface 410 may require that a vendor visit a particular store. The system 400 may then require that a manager with an appropriate permission level initiate the operations timer reset of the user interface 410 to reset the vendor timer. This may ensure that the vendor not only visited the store but checked to make sure that the store did or did not require restocking. In another preferred embodiment, the system 400 may save which tasks the employee has completed and when they were completed.

The system 400 may use indicia to indicate when a task needs completion or when a user is compliant or non-complaint. Indicia may be displayed in the user interface 410 as, but are not limited to, text, highlights, checks, X's, strikethroughs, symbols, images, or any other suitable indicator. For instance, an operations timer that has not finished a countdown may be highlighted in green to indicate that there is still time to complete the task (user is compliant), whereas an operations timer that has finished a countdown may be highlighted in red to indicate that this task needs to be completed immediately (user is not compliant). In another preferred embodiment, the indicia displayed to a user 405 may be determined by the system 400 using an urgency level of the operations timer. The indicia determined using urgency parameters may be in addition to indicia that indicate compliance or they may be in lieu of said indicia that indicate compliance. In a preferred embodiment, the urgency level may be a value assigned to an operations timer based on a set of urgency parameters and urgency thresholds 435B. Urgency parameters that may be used to create the urgency level include, but are not limited to, overdue task, task type, time of day, time of year, or any combination thereof. For instance, an urgency level for a vendor to visit a particular location may be “low priority” if the vendor recently visited that retail store during a time of year in which there is low demand for the vendor's items; however, the system 400 may still indicate to the vendor whether or not they are compliant with a vendor timer. For instance, an urgency level of a maintenance timer may be “highest priority” after a manager has noted a spill that must be cleaned up. This “highest priority” urgency level may additionally cause the system 400 to change whatever indicia the system 400 normally uses to indicate compliance to an indicia that indicates that this task now takes priority over other tasks.

The system 400 may also include a user 405 history that may be viewed within the user interface 410. The user 405 history may include data that may be indicative of whether or not a user 405 has complied with timers of the system 400. In one preferred embodiment, each timer reset may indicate whether a user 405 has or has not complied with a timer via a compliance status, wherein the system 400 may return a “complied” or “not complied” compliance status. In a preferred embodiment, when the system 400 generates a “complied” compliance status, data associated with that timer reset may be colored green, and when the system 400 generates a “not complied” compliance status, data associated with that timer reset may be colored red. In another preferred embodiment, the user 405 history may further comprise a compliance timeline that is navigable by a user 405. The compliance timeline may be defined as a chronological ordering of timer resets made by a particular user 405 over a given time period represented by a line indicating a linear time interval. In another preferred embodiment, indicia may be used to indicate which timer resets along the compliance timeline were reset before or after a compliance period. In a preferred embodiment, timers reset before a compliance period was up may be colored green and timers reset after a compliance period was up may be colored red.

The system 400 may also be used to keep track of valuable equipment owned by a retail store and used by its employees. In a preferred embodiment, the scanning device 412 of the system 400 may be used to scan a piece of equipment 407 and then associate said piece of equipment 407 with a user profile 420. In a preferred embodiment, a user 405 may use the scanning device 412 after having logged into their user profile 420, which may allow the system 400 to associate the equipment with the correct user profile 420. The scanning device 412 may also be used to scan the same piece of equipment 407 at a later time to dissociate the piece of equipment 407 with the user profile 420. In one preferred embodiment, the system 400 may require a user 405 having appropriate permission levels to dissociate a piece of equipment 407 with a user profile 420. For instance, the system 400 may require a store manager to input a code to dissociate a piece of equipment 407 associated with a user profile 420. The system 400 may also alert a user 405 when a piece of equipment 407 is already associated with another user profile 420. For instance, a manager may be alerted by the system 400 when an employee attempts to associated a piece of equipment 407 with their user profile 420 when it is already associated with another user profile 420. In a preferred embodiment, the system 400 may create an equipment log from the association data and dissociation data, which may be saved within the system 400.

In a preferred embodiment, a user 405 may be required to be associated with a piece of equipment 407 before the user 405 may reset a particular timer. For instance, a user 405 may be required to scan a broom in a way such that the system 400 associates the broom with the user 405 before said user 405 may be allowed to reset a maintenance timer. In another preferred embodiment, the timer may require a certain amount of time to have passed after an event has occurred before a timer can be reset. For instance, the system 400 may require ten minutes to elapse since the user 405 has been associated with a mop before the user 405 may be allowed to reset a maintenance timer. For instance, the system 400 may require that at least half of a timer elapse before a user 405 may reset a restocking timer. In yet another preferred embodiment, the system 400 may require that a user 405 be unassociated with a piece of equipment 407 before the user 405 may reset an operation timer. For instance, a user 405 may be required to scan a bar code of a bar code scanning device 412 in a way such that the system 400 un-associates the bar code scanning device 412 with the user 405 before the system 400 will allow a user 405 to reset a restocking timer.

The system 400 may also be used to keep track of when vendors have visited a particular user 405 and whether or not the vendor has signed an up-to-date vendor agreement. In a preferred embodiment, a vendor is a user 405 of the system 400. In one preferred embodiment, a vendor may be a subgroup within the system 400. A vendor agreement may be defined as an agreement that states that a vendor will adhere to the retailers' policies and regulations while at the user's 405 location. The system 400 may require that a vendor sign an updated vendor agreement before any vendor timer may be reset. The system 400 may also require that a user 405 other than the vendor be present before a vendor timer may be reset by the system 400.

To prevent un-authorized users 405 from accessing other user's 405 information and customer's 406 information, the system 400 may employ a security method. As illustrated in FIG. 7, the security method of the system 400 may comprise a plurality of permission levels 700 that may grant users 405 access to content 715, 735, 755 within the database 115 while simultaneously denying users 405 without appropriate permission levels 700 the ability to view content 715, 735, 755. To access the content 715, 735, 755 stored within the system 400, users 405 may be required to make a request via the user interface 410. Access to the data within the system 400 may be granted or denied by the processor 220 based on verification of a requesting user's 705, 725, 745 permission level 700. If the requesting user's 705, 725, 745 permission level 700 is sufficient, the processor 220 may provide the requesting user 705, 725, 745 access to content 715, 735, 755 stored within the system 400. Conversely, if the requesting user's 705, 725, 745 permission level 700 is insufficient, the processor 220 may deny the requesting user 705, 725, 745 access to content 715, 735, 755 stored within the system 400. In an embodiment, permission levels 700 may be based on user roles 710, 730, 750 and administrator roles 770, as illustrated in FIG. 7. User roles 710, 730, 750 allow requesting users 705, 725, 745 to access content 715, 735, 755 that a user 405 has uploaded and/or otherwise obtained through use of the system 400. Administrator roles 770 allow administrators 765 to access system 400 wide data.

In an embodiment, user roles 710, 730, 750 may be assigned to a user 405 in a way such that a requesting user 705, 725, 745 may view user profiles 420 containing item data 430A and customer profiles 425 containing customer data 425A via a user interface 410. To access the data within the system 400, a user 405 may make a user request via the user interface 410 to the processor 220. In an embodiment, the processor 220 may grant or deny the request based on the permission level 700 associated with the requesting user 705, 725, 745. Only users 405 having appropriate user roles 710, 730, 750 or administrator roles 770 may access the data within the user profiles 420 and customer profiles 425. For instance, as illustrated in FIG. 7, requesting user 1 705 has permission to view user 1 content 715 and user 2 content 735 whereas requesting user 2 725 only has permission to view user 2 content 735. Alternatively, content 715, 735, 755 may be restricted in a way such that a user 405 may only view a limited amount of content 715, 735, 755. For instance, requesting user 3 745 may be granted a permission level 700 that only allows them to view content 755 related to a specific customer but not content 755 related to other users 715, 735. In the example illustrated in FIG. 7, an administrator 765 may bestow a new permission level 700 on users 405 so that it may grant them greater permissions or lesser permissions. For instance, an administrator 765 may bestow a greater permission level 700 on other users so that they may view customer content 755 and/or any other user's content 715, 735. Therefore, the permission levels 700 of the system 400 may be assigned to users 405 in various ways without departing from the inventive subject matter described herein.

FIG. 8 provides a flow chart 800 illustrating certain, preferred method steps that may be used to carry out the method of generating a return action 620 for a returned identifiable item 408. Step 805 indicates the beginning of the method. During step 810 the scanning device 412 may scan customer identification and transmit customer data 425A to the processor 220. The processor 220 may then perform a query during step 815 to determine whether or not a customer profile 425 matches the customer data 425A received from the scanning device 412. Based on the results of the query, the system 400 may take an action during step 820. If the system 400 determines that no customer profile 425 matches the received customer data 425A, the system 400 may create a customer profile 425 during step 822 before proceeding to transmit the customer profile 425 to the processor 220 during step 825. If the processor 220 determines that a customer profile 425 matching the received customer data 425A does exist, the processor 220 may transmit the customer profile 425 to the processor 220 during step 825. Once the processor 220 has received the customer profile 425, the scanning device 412 may transmit item data 430A from an identifiable item 408 to the processor 220 during step 830.

In one preferred embodiment, a user 405 may be required to input item data 430A or customer data 425A into the user interface 410. For instance, the user 405 may be required to input the purchase price of the identifiable item 408 into the user interface 410. For instance, a user 405 may be required to input a “reason for return” into the user interface 410. Once the item data 430A and customer data 425A have been received by the processor 220, the processor 220 may generate a return action 620 during step 835. In a preferred embodiment, the system 400 may generate an “invalid” return action 620 or an “allowed” return action 620 before displaying the return action 620 to the user 405 via the user interface 410, wherein an “invalid” return action 620 would indicate to a user 405 that the customer 406 should not be allowed to return an identifiable item 408 and an “allowed” return action 620 may indicate to a user 405 that the customer 406 should be allowed to return an identifiable item 408. Once the system 400 has generated the return action 620, the system 400 may take an action based on the return action 620 during step 840. If the return is not allowed by the system 400, the system 400 may proceed to the terminate method step 850. In one preferred embodiment, a user 405 with appropriate permission levels may allow a customer 406 to return an identifiable item 408 despite the return action 620 generated by the system 400. If the return is allowed by the system 400, the system 400 may process the return during step 845. Once the system 400 has processed the return, the system 400 may proceed to the terminate method step 850.

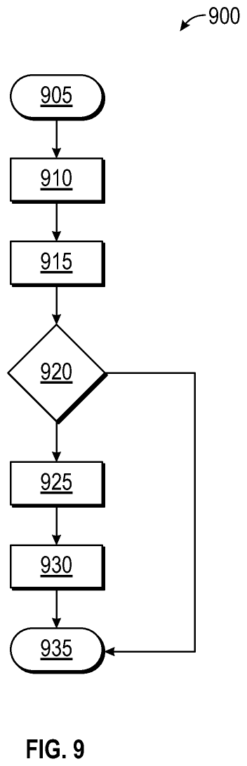

FIG. 9 provides a flow chart 900 illustrating certain, preferred method steps that may be used to carry out the method of creating an operations timer for a user 405. Step 905 indicates the beginning of the method. During step 910 the processor 220 may receive a create operations timer request from the user interface 410. The processor 220 may then perform a query to determine whether or not the user 405 has an appropriate permission level to create operations timer during step 915. The system 400 may take an action based on the results of this query during step 920. If the system 400 determines the user 405 does not have the appropriate permissions to create an operations timer, the system 400 may proceed to the terminate method step 935. If the system 400 determines that the user 405 does have the appropriate permissions to create an operations timer, the processor 220 may proceed to step 925, wherein the user 405 may input timer parameters into the user interface 410. In a preferred embodiment, timer parameters that may be input by a user 405 include timer name and timer length. A user 405 may also input urgency parameters into the user interface 410 that will allow the processor 220 to determine which tasks most urgently need completion. Once the user 405 has input the timer parameters, the system 400 may save the operations timer during step 930 and subsequently proceed to the terminate method step 935.

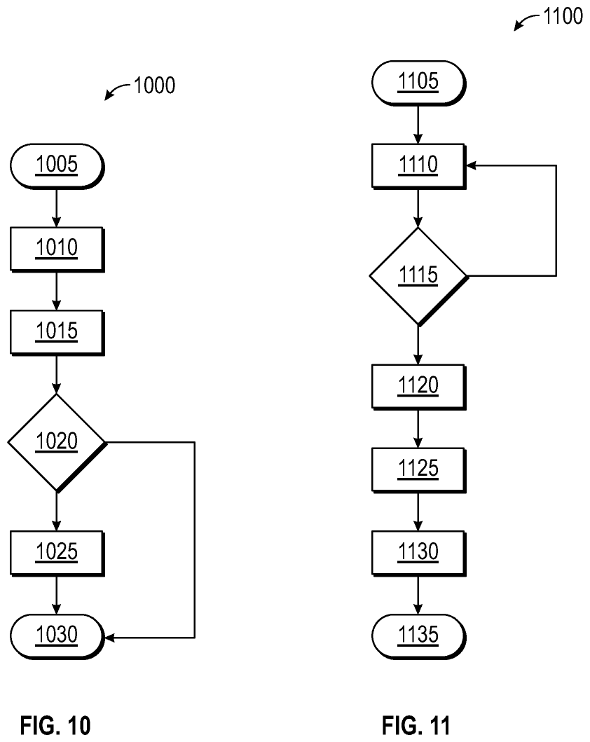

FIG. 10 provides a flow chart 1000 illustrating certain, preferred method steps that may be used to carry out the method of resetting an operations timer. Step 1005 indicates the beginning of the method. During step 1010, the processor 220 may receive an operations timer reset from the user interface 410. The processor 220 may then perform a query during step 1015 to determine whether or not the user 405 has the appropriate permission levels to reset the operations timer. Based on the results of the query, the processor 220 may take an action during step 1020. If the processor 220 determines that the user 405 does not have the appropriate permission levels to reset the operations timer, the system 400 may proceed to the terminate method step 1030. If the processor 220 determines that the user 405 does have the appropriate permission levels, the processor 220 may reset the timer during step 1025. Once the processor 220 has reset the operations timer, the method may proceed to terminate method step 1030. In one preferred embodiment, a user 405 may be required to be in a particular geolocation before the system 400 may allow the user 405 to reset an operations timer. In another preferred embodiment, multiple variables may have to be present in order for an operations timer to be reset. For instance, a vendor timer may require a vendor to sign into the system 400 at a store having a particular geolocation (as defined in the timer parameters) and a manager ID badge to reset a vendor timer. For instance, a user 405 may be required to un-associate a piece of equipment 407 with their user profile 420 before the system 400 will allow the user 405 to reset a restocking timer. For instance, the system 400 may require the user 405 take an image of an area that required maintenance before the system 400 will allow the user 405 to reset a maintenance operations timer.

FIG. 11 provides a flow chart 1100 illustrating certain, preferred method steps that may be used to carry out the method of generating and displaying an urgency level for an operations timer. Step 1105 indicates the beginning of the method. During step 1110, the processor 220 may perform a query to determine if any urgency variable have changed for any of the operations timers of the system 400. Based on the results of the query, the processor 220 may take an action during step 1115. If the processor 220 determines that no urgency variables have changed for any of the operations timers of the system 400, the processor 220 may return to step 1110. If the system 400 determines that urgency variables have changed, the system 400 may proceed to step 1120 and determine an urgency level for each of the timers.

In a preferred embodiment, the urgency level may be determined by using an urgency threshold 435B. Urgency thresholds 435B may be defined as the total value of threshold parameters of an operations timer required to reach a particular urgency level. In a preferred embodiment, higher urgency levels have higher urgency parameter point requirements. Urgency parameters that may be used to create the urgency level include, but are not limited to, overdue task, task type, time of day, time of year, or any combination thereof. For instance, an operations timer having an overdue task parameter may be assigned fifteen points when the task is overdue. Additionally, that same operations timer may be assigned an additional fifteen points or have fifteen points removed depending on the time of day and/or time of year. Additionally, the operations timer may have an additional points value assigned depending on the type of task. For instance, a maintenance timer may be assigned additional points in order to prevent fraudulent fall claims whereas a restocking timer may be assigned no additional points.

Once the system 400 has determined the urgency level for each of the operations timers, the processor 220 may assign an indicia to each operations timer during step 1125. In a preferred embodiment, the urgency level of an operations timer is indicated by the color in which the operations timer is highlighted. Once the processor 220 has an assigned an indicia to each operations timer, the system 400 may display the operations timers to the user 405 via the user interface 410 during step 1130. Once the operations timers have been displayed to the user 405, the system 400 may proceed to the terminate method step 1135.

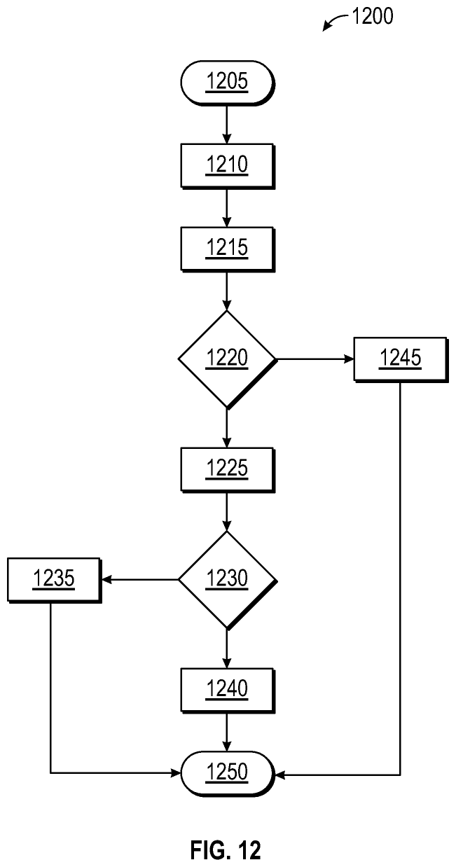

FIG. 12 provides a flow chart 1200 illustrating certain, preferred method steps that may be used to carry out the method of assigning pieces of equipment to user profiles 420. Step 1205 indicates the beginning of the method. During step 1210, the processor 220 may receive equipment data from the scanning device 412. Once the processor 220 has received the equipment data, the processor 220 may perform a query to determine whether or not the piece of equipment 407 is already associate with a user profile 420 during step 1215. Based on the results of that query, the processor 220 may take an action during step 1220. If the processor 220 determines that the piece of equipment 407 is not already associated with a user profile 420, the system 400 may associate said equipment with said user profile 420 during step 1245. Once the system 400 has associated the piece of equipment 407 with the user profile 420, the method may proceed to the terminate method step 1250.

If the processor 220 determines that the piece of equipment 407 is already associated with a user profile 420, the processor 220 may proceed to step 1225, wherein the processor 220 may perform a query to determine whether or not the piece of equipment 407 is currently associated with the current user profile 420 or another user profile 420. Based on the results of that query, the processor 220 may take an action during step 1230. If the processor 220 determines that the piece of equipment 407 is associated with another user profile 420, the system 400 may submit an error message to the user 405 via the user interface 410 during step 1235. In one preferred embodiment, a user 405 having management privileges may also be alerted when a user 405 attempts to associate a piece of equipment 407 with their user profile 420 when that piece of equipment 407 is already associated with another user profile 420. Once the processor 220 has sent the error message, the method may proceed to the terminate method step 1250. If the system 400 determines that the piece of equipment 407 is associated with the current user profile 420, the system 400 may dissociate the piece of equipment 407 with the user profile 420 during step 1240 and subsequently proceed to the terminate method step 1250.

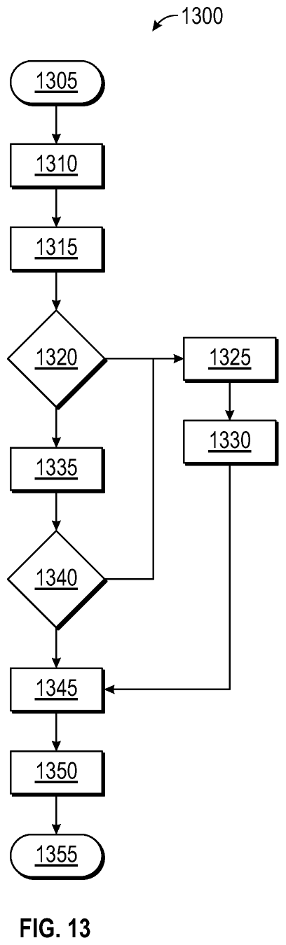

FIG. 13 provides a flow chart 1300 illustrating certain, preferred method steps that may be used to carry out the method of updating a vendor agreement and resetting a vendor timer. Step 1305 indicates the beginning of the method. During step 1310, the processor 220 may acquire a vendor's user 405 information. The processor 220 may then perform a query to determine if the vendor has signed a vendor agreement during step 1315. In another preferred embodiment, the system 400 may require a manager's credentials before performing a query to determine whether a vendor agreement has been signed. Based on the results of the query, the processor 220 may perform an action during step 1320. If the processor 220 determines that the vendor has not signed a vendor agreement, the system 400 may retrieve the most recent vendor agreement from the system 400 and present it to the user 405 during steps 1325 and 1330, respectively. Once the user 405 has signed the vendor agreement, the processor 220 may proceed to step 1345.

If the processor 220 determines that the user 405 has signed a vendor agreement, the processor 220 may perform a query to determine if the vendor agreement is the most recent version of the vendor agreement during step 1335. Based on the results of the query, the processor 220 may take an action during step 1340. If the processor 220 determines that the vendor agreement is an up-to-date vendor agreement, the processor 220 may proceed to step 1345. If the processor 220 determines that the vendor agreement is not a most recent version of the vendor agreement, the system 400 may retrieve the most recent vendor agreement from the system 400 and present it to the user 405 during steps 1325 and 1330, respectively. Once the user 405 has signed the vendor agreement, the processor 220 may proceed to step 1345. During step 1345, the system 400 may acquire management credentials from a manager. Once the processor 220 has acquired management credentials from the manager, the processor 220 may reset the vendor timer during step 1350. The method may then proceed to the terminate method step 1355.

The subject matter described herein may be embodied in systems, apparati, methods, and/or articles depending on the desired configuration. In particular, various implementations of the subject matter described herein may be realized in digital electronic circuitry, integrated circuitry, specially designed application specific integrated circuits (ASICs), computer hardware, firmware, software, and/or combinations thereof. These various implementations may include implementation in one or more computer programs that may be executable and/or interpretable on a programmable system including at least one programmable processor, which may be special or general purpose, coupled to receive data and instructions from, and to transmit data and instructions to, a storage system, and at least one peripheral device.

These computer programs, which may also be referred to as programs, software, applications, software applications, components, or code, may include machine instructions for a programmable processor, and may be implemented in a high-level procedural and/or object-oriented programming language, and/or in assembly machine language. As used herein, the term “non-transitory computer-readable medium” refers to any computer program, product, apparatus, and/or device, such as magnetic discs, optical disks, memory, and Programmable Logic Devices (PLDs), used to provide machine instructions and/or data to a programmable processor, including a non-transitory computer-readable medium that receives machine instructions as a computer-readable signal. The term “computer-readable signal” refers to any signal used to provide machine instructions and/or data to a programmable processor. To provide for interaction with a user, the subject matter described herein may be implemented on a computer having a display device, such as a cathode ray tube (CRD), liquid crystal display (LCD), light emitting display (LED) monitor for displaying information to the user and a keyboard and a pointing device, such as a mouse or a trackball, by which the user may provide input to the computer. Displays may include, but are not limited to, visual, auditory, cutaneous, kinesthetic, olfactory, and gustatory displays, or any combination thereof.

Other kinds of devices may be used to facilitate interaction with a user as well. For instance, feedback provided to the user may be any form of sensory feedback, such as visual feedback, auditory feedback, or tactile feedback; and input from the user may be received in any form including, but not limited to, acoustic, speech, or tactile input. The subject matter described herein may be implemented in a computing system that includes a back-end component, such as a data server, or that includes a middleware component, such as an application server, or that includes a front-end component, such as a client computer having a graphical user interface or a Web browser through which a user may interact with the system described herein, or any combination of such back-end, middleware, or front-end components. The components of the system may be interconnected by any form or medium of digital data communication, such as a communication network. Examples of communication networks may include, but are not limited to, a local area network (“LAN”), a wide area network (“WAN”), metropolitan area networks (“MAN”), and the internet.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For instance, the implementations described above can be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, devices, and arrangements of the parts and method stages which have been described and illustrated in order to explain the nature of this inventive subject matter can be made without departing from the principles and scope of the inventive subject matter.

What is claimed is:

1. A system for preventing losses comprising:
a computing entity,
wherein said computing entity allows a user to connect to a network via a user interface,
a processor operably connected to said computing entity via said network,
wherein said processor interacts with said computing entity via said user interface based on commands,
a scanning device operably connected to said processor, and
a non-transitory computer-readable medium coupled to said processor,
wherein said non-transitory computer-readable medium contains customer profiles having customer data,
wherein said non-transitory computer-readable medium contains instructions stored thereon, which, when executed by said processor, cause said processor to perform operations comprising:
receiving customer data from said scanning device,
receiving item data from said scanning device,
associating said customer data with said customer profiles,
generating a return action based on said customer data and said item data, and
displaying said return action to said user within said user interface.

2. The system of claim 1, further comprising:
a database operably connected to said processor,
wherein said database is configured to save said customer profiles, and
additional instructions stored on said non-transitory computer-readable medium, which, when executed by said processor, cause said processor to perform additional operations comprising:
transmitting said customer profiles to said database,
saving said customer profiles in said database, and
retrieving said customer profiles from said database.

3. The system of claim 1, further comprising permission levels, wherein said permission levels limit access to said customer profiles within said system.

4. The system of claim 1, further comprising user profiles,
wherein said user profiles are associated with said user of the system, and
wherein said user interface is configured to allow said user to access said system via said user profiles.

5. The system of claim4 4, further comprising permission levels, wherein said permission levels limit access to user data and said customer data within said system.

6. The system of claim4 4, wherein said non-transitory computer-readable medium contains additional instructions, which, when executed by said processor, cause said processor to perform additional operations comprising:
receiving equipment data from said scanning device,
associating said equipment data with said user profiles when a piece of equipment is not already associated with said user profiles, and
dissociating said equipment data with said user profiles when said piece of equipment is already associated with said user profiles.

7. The system of claim4 4, wherein said user interface comprises an operations timer,
wherein said operations timer uses indicia to indicate a user action that should be taken by said user, and
wherein said user action is based on an urgency level of said operations timer.

8. The system of claim 7, wherein said non-transitory computer-readable medium contains additional instructions, which, when executed by said processor, cause said processor to perform additional operations comprising:
receiving an operations timer reset from said computing entity,
checking said operations timer reset against said operations timer, and
resetting said operations timer based on said operations timer reset.

9. The system of claim 8, wherein said operations timer comprises permission levels, wherein said permission levels limit said user profiles allowed to reset said operations timer.

10. The system of claim 8, wherein said operations timer comprises at least one of a restocking timer, maintenance timer, management timer, and vendor timer.

11. A system for preventing losses comprising:
a computing entity,
wherein said computing entity allows a user to connect to a network via a user interface having an operations timer,
wherein said operations timer uses indicia to indicate a user action that should be taken by said user[[s]],
wherein said user action is based on an urgency level of said operations timer,
a processor operably connected to said computing entity via said network,
wherein said processor interacts with said computing entity via said user interface based on commands, and
a non-transitory computer-readable medium coupled to said processor,
wherein said non-transitory computer-readable medium contains user profiles having user data,
wherein said non-transitory computer-readable medium contains instructions stored thereon, which, when executed by said processor, cause said
processor to perform operations comprising: receiving an operations timer reset from said computing entity, checking said operations timer reset against said operations timer, and resetting said operations timer based on said operations timer reset.

12. The system of claim 11, further comprising:
a database operably connected to said processor,
wherein said database is configured to save said customer profiles, and
additional instructions stored on said non-transitory computer-readable medium, which, when executed by said processor, cause said processor to perform additional operations comprising:
transmitting said user profiles to said database,
saving said user profiles in said database, and
retrieving said user profiles from said database.

13. The system of claim 11, further comprising permission levels, wherein said permission levels limit access to said user profiles within said system.

14. The system of claim 11, wherein said operations timer comprises permission levels, wherein said permission levels limit said user profiles allowed to reset said operations timer.

15. The system of claim 11, wherein said operations timer comprises at least one of a restocking timer, maintenance timer, management timer, and vendor timer.

16. The system of claim 11, wherein said system further comprises a scanning device operably connected to said processor.

17. The system of claim 16, wherein said non-transitory computer-readable medium contains additional instructions, which, when executed by said processor, cause said processor to perform additional operations comprising:
receiving equipment data from said scanning device,
associating said equipment data with said user profiles when a piece of equipment is not already associated with said user profiles, and
dissociating said piece of equipment with said user profiles when said equipment data is already associated with said user profiles.

18. A system for preventing losses comprising:
a computing entity,
wherein said computing entity allows a user to connect to a network via a user interface,
a processor operably connected to said computing entity via said network,
wherein said processor interacts with said computing entity via said user interface based on commands,
a scanning device operably connected to said processor,
wherein said scanning device allows said user to scan a customer identification and identifiable item in a way such that said processor determines a return action, and
a non-transitory computer-readable medium coupled to said processor,
wherein said non-transitory computer-readable medium contains user profiles having user data,
wherein said non-transitory computer-readable medium contains instructions stored thereon, which, when executed by said processor, cause said processor to perform operations comprising:
receiving an equipment profile from said scanning device,
associating said equipment profile with said user profiles when said equipment profile is not already associated with said user profiles, and
dissociating said equipment profile with said user profiles when said equipment profile is already associated with said user profiles.

19. The system of claim 18, further comprising permission levels, wherein said permission levels limit access to data within said system.

20. The system of claim 18, wherein said user interface further comprises a plurality of operations timers that use indicia to indicate a user action.
